(19) United States
(12) Patent Application Publication
(10) Pub. No.: US 2007/0253435 A1
(43) Pub. Date: Nov. 1, 2007

(54) METHOD FOR PROVIDING RELIABLE SESSION COMMUNICATION WITHIN A NETWORK

(75) Inventors: Matthew C. Keller, Algonquin, IL (US); Shanthi E. Thomas, Carpentersville, IL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(73) Assignee: MOTOROLA, INC., Plantation, FL (US)

(21) Appl. No.: 11/381,020

(22) Filed: May 1, 2006

(51) Int. Cl. H04L 12/56

(52) U.S. Cl. 370/401; 370/389

(57) ABSTRACT

A method of network operation provides reliable session communication within a communication network. A communication session is initiated by an endpoint using a transactional protocol to send a communication session request to a server. The server sends a second communication session request to the at least one other endpoint. An announcement is generated and sent using a broadcast protocol from the server to the at least one other endpoint. The communication session is thereafter started by the at least one other endpoint in response to receiving the broadcast protocol announcement.

### FIELD OF INVENTION

The present invention relates generally to communication networks, and more specifically to providing reliable session communication among two or more entities within a communication network.

### BACKGROUND

Multimedia and group communications have become an important aspect of telecommunications, and the demand for such continues to increase. For instance, the Final Report of the Public Safety Wireless Advisory Committee to the Federal Communications Committee (“FCC”), dated 1996, expressed the critical need for communication resources for multimedia. Subsequently in 1998, the FCC established a band plan for the 764 Megahertz (MHz) frequencies that included spectrum set aside for public safety wideband. In addition, the Internet Engineering Task Force (“IETF”) has developed a suite of protocols that are designed for use in multimedia communications. These protocols include a Session Initiation Protocol (“SIP”), a Session Announcement Protocol (“SAP”), and a Session Description Protocol (“SDP”).

Since its approval in early 1999 as an official standard, SIP has gained tremendous market acceptance for signaling communications services on the Internet. As such, numerous products incorporate the SIP standard, including but not limited to SIP desktop telephones, SIP telephony servers, and personal computing (“PC”) devices running SIP applications. SIP is a text-based signaling transactional protocol, similar to Hypertext Transfer Protocol (“HTTP”) and Simple Mail Transfer Protocol (“SMTP”), and works in the Application layer of the Open Systems Interconnection (“OSI”) communications model. A SIP message is used to initiate an interactive communications session, such as voice, video, and chat, between users (also referred to herein as callers) in a communications network. Each user is typically associated with a communications device (also referred to herein as a terminal device or an endpoint) that is connected to the network.

SIP (for example, SIP RFC [3261]) is not only used to initiate sessions, SIP messages are also used to terminate and to modify sessions. SIP does not, however, actually define what a “session” is, e.g., which Internet Protocol (“IP”) channel (addresses and ports), media codec specification, floor control channels, etc., are to be used during the session. This is described by content carried in the SIP messages. SIP conveys information about the protocol used to describe the session through multipurpose Internet mail extensions (MIME), widely used in web and e-mail services to describe content (HTML, audio, video, etc.). The most common protocol used to describe sessions is SDP, described in the IETF Request for Comments [RFC]2327. SIP can also be used to negotiate a common format for describing sessions, so that other protocols besides SDP can be used.

SIP is based on the request-response paradigm. Thus, to initiate a session, a caller who is associated with an initiating endpoint sends a request (called an INVITE) addressed to the user, associated with a recipient endpoint, that the caller wants to talk to. In SIP, addresses are Uniform Resource Locators (“URLs”). SIP defines a URL format that is very similar to the popular mailto URL. For instance, if the user's e-mail address is janedoe@company.com, the SIP URL would be sip:janedoe@company.com. Once the user has been located and the session description delivered, SIP is used to convey the response to the session initiation (accept, reject, etc.). If accepted (via a SIP OK), the session is now active, wherein a SIP ACK is then sent from the initiating endpoint to the recipient endpoint.

In SIP, a successful INVITE/OK/ACK exchange creates a SIP control dialog (also referred to as a SIP dialog, a call leg or a SIP transaction). Once a session is active, SIP can be used to modify the session as well. To modify a session, the initiating endpoint simply re-initiates the session, sending the same message as the original, but with a new session description. For this reason, modification of sessions (which includes things like adding and removing audio streams, adding video, changing codecs, hold and mute) are easily supported with SIP, so long as the session description protocol can support them (SDP supports all of the above). Finally, SIP can be used to terminate the session. Sending a SIP BYE message performs this function.

The SIP protocol was targeted primarily for Internet applications, where a very high percentage of the time there is no packet loss. One drawback to this approach is that when higher rates of packet loss are introduced, for example when using SIP over a wireless network, the success of the call setup SIP signaling between clients can be affected. Further, there are situations where the two clients can have a different view of the call state. This situation gets more complex and more troublesome when a call server is also involved in the call setup as it provides another signaling hop and another entity which has to maintain state consistent with the two clients. Not having consistent state across the clients and server can result in “stuck calls” where the server thinks there is a call going and has resources reserved for that call, but the clients do not believe it exists and therefore will never end the call.

When a user sets up a multimedia session, the initiator client sends a SIP INVITE message to either the inbound proxy or directly to the address specified by the target Uniform Resource Identifiers (URI). In many commercial SIP systems, the client sends the INVITE to a call control server acting as the inbound proxy. This call control server can then enact any call control rules (i.e. enforce session limitations, authorizations, bandwidth reservations, and the like) and decide whether to proceed with the call. If the call setup proceeds, the server will send a new INVITE message to the target client. This is what is known in the industry as a back to back user agent (B2BUA). Once the server receives an OK response from the target client, it can send an OK to the initiator. At this point the server considers the call to be setup. As noted above, communication problems can cause the loss of one or more messages. Depending on the message lost, various mismatches of state can occur between the initiator, call control server, and target.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates an exemplary block diagram of a call model architecture.

FIG. 2 illustrates an exemplary layered view of the call model architecture of FIG. 1.

FIG. 3 illustrates an exemplary layered view of the call model architecture of FIG. 2.

FIGS. 4 through 6 are exemplary message sequence diagrams in accordance with some embodiments of the invention.

FIG. 7 is a table illustrating the application of some embodiments of the present invention to various error states associated with the message sequence diagrams of FIGS. 4 through 6.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to provide reliable session initiation protocol calls. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of providing reliable session initiation protocol calls described herein. The non-processor circuits may include, but are not limited to, a radio receiver, a radio transmitter, signal drivers, clock circuits, power source circuits, and user input devices. As such, these functions may be interpreted as steps of a method to perform reliable session initiation protocol calls. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and integrated circuits (ICs) with minimal experimentation.

The present invention combines traditional SIP setup mechanisms with a session announcement mechanism to provide reliable session setup and consistent session state among all components. When the call server believes that the call is setup (it has received a response from the target and sent a response to the initiator), it will start sending periodic session announcements using the Session Announcement Protocol (SAP) to a predetermined announcement address.

SAP is a broadcast protocol that is defined in IETF Request for Comments (RFC)2974. SAP is used by a session directory server, referred to as a SAP announcer, to announce multicast based conferences, wherein, for instance, multimedia files (usually audio and video streams) are sent to multiple users at the same time somewhat as radio and television programs are broadcast over airwaves. Although SAP is scalable for large group communications, a shortcoming of how SAP is currently implemented is that it has a low update or announcement rate that does not support dynamically assigned sessions.

Coordinating session announcement addresses can be achieved through common configuration or alternatively can be learned during registration. Clients start listening for announcements on that address when they are ready to start accepting sessions.

Using the mechanisms of the present invention, the session initiator, the target, and the call control server can coordinate their state in the case of lost messages.

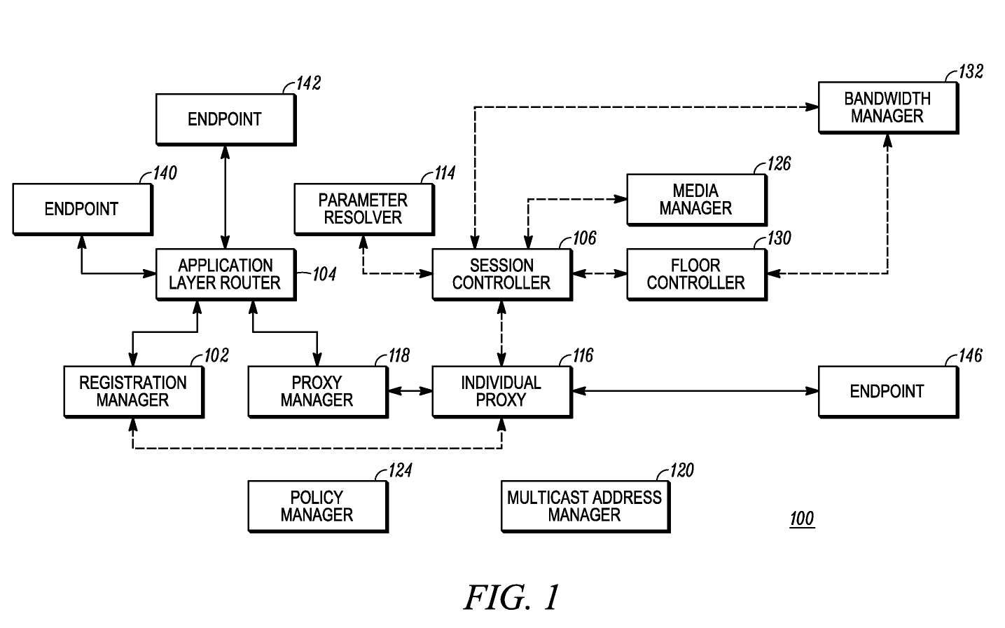

FIG. 1 illustrates a call control architecture 100 comprising a number of entities; and associated communication paths for enabling communications between at least two endpoints within a communications system. Each endpoint typically comprises a logical entity, e.g., a user, and a physical counterpart, e.g., a terminal. Entities connected with solid black lines communicate using a transactional protocol or a broadcast protocol. The preferred transactional protocol is SIP, and the preferred broadcast protocol is SAP. It will be appreciated that other entities connected with dashed lines communicate using appropriate protocol known in the art. The architecture 100 is especially applicable to time critical communications systems such as public safety dispatch systems.

For enabling communications between at least two endpoints (e.g., endpoints 140, 142, and/or 146 of FIG.1), architecture 100 includes a session controller 106. To further facilitate application layer routing, architecture 100 includes a registration manager 102, and an application layer router 104 that is preferably a SIP proxy. Architecture 100 also includes a parameter resolver 1 14, at least one individual proxy 1 16, an individual proxy manager 1 18, a multicast address manager 120, a policy manager 124, a floor controller 130, a media manager 126, and a bandwidth manager 132. Architecture 100 is simplified for purposes of illustrating the present invention. However, those of ordinary skill in the art will realize that architecture 100 may comprise any appropriate combination of the illustrated entities including a plurality of each illustrated entity as a function of the size of the communication system. Architecture 100 is configured to be independent of an underlying network and air interface and relies on entities such as the bandwidth manager 132 for network specific functionality.

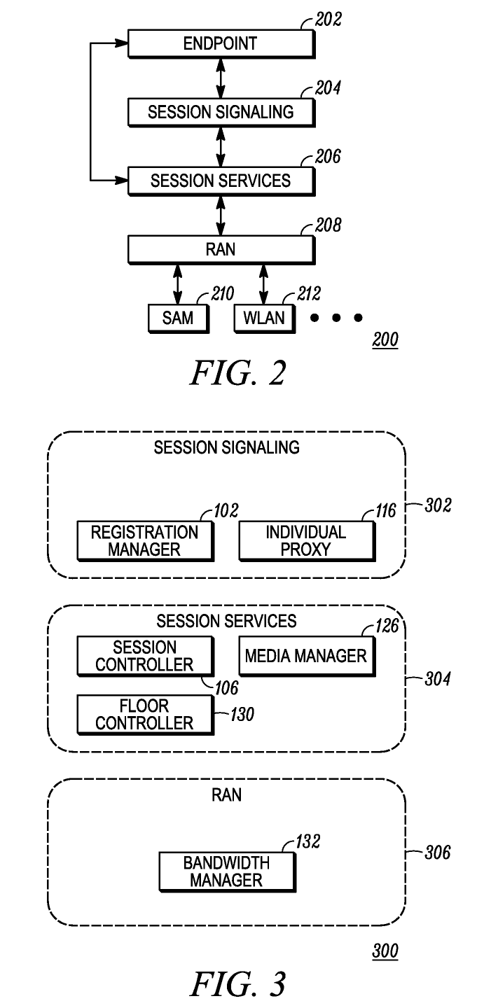

Architecture 100 can be abstracted into a layered view 200 as shown in FIG. 2 including a session signaling layer 204, a session services layer 206, and a Radio Access Network (RAN) layer 208. The session signaling layer 204 terminates session control signaling such as SIP, SAP, and SDP that may be used in combination to initiate, modify, and terminate sessions. The session signaling layer 204 further makes requests into and receives events, e.g., lack of bandwidth, from the session services layer 206. The session services layer 206 provides session services such as session interaction for prioritization and preemption and for features such as critical users. The session services layer 206 further enforces system policies such as allowing a user to make a certain call type or to use a certain amount of bandwidth, and also provides in-session services such as floor control or media management services (e.g. transcoding) directly to an endpoint, e.g., endpoint 202. The RAN layer 208 is aware of an underlying wireline and wireless network implementations, e.g., a SAM (Scalable Adaptive Modulation) 210 and a Wireless Local Area Network (WLAN) 212, and provides network specific functionality to support the session services layer 206. This functionality includes bandwidth management for the various wired and wireless links and location management of the terminals in the system.

The layered view 200 of FIG. 2 is beneficial in that each of the layers can be modified independently of the other layers. For instance, the session signaling layer 204 can be changed without affecting the other layers, if use of a different call control protocol is desired. Moreover, such a layered approach enables architecture 100 to support various air interfaces and mobility schemes without affecting the session services or session signaling.

FIG. 3 illustrates a layered view 300 of architecture 100 as well as the allocation of the components of the architecture 100 to the various layers. As illustrated, the registration manager 102 and the individual proxy 116 are allocated to the session signaling layer 302. The session controller 106, the media manager 126 and the floor controller 130 are allocated to the session services layer 304, and the bandwidth manager 132 is allocated to the RAN layer 306. As will be explained in more detail below, the interfaces between the session controller 106 and the individual proxy 116 and the bandwidth manager 132 provides flexibility to accommodate systems that use different RANs or different session signaling protocols. Moreover, this layered approach maintains the standard SIP transactional model from the point of view of the endpoints, thereby, simplifying inter-working with both dispatch and non-dispatch endpoints and enabling effective leveraging of future SIP standards and products.

Architecture 100 preferably supports both confirmed and unconfirmed session setup methods. In an unconfirmed session setup, session notifications to the endpoints are not acknowledged. Unconfirmed session setups are, thus, typically automatically accepted by a target terminal without human intervention (e.g. without providing the target users an opportunity to decline the session or to indicate a preferred terminal to utilize). Unconfirmed session setup methods may be used, for instance, for mission critical group dispatch sessions since such sessions typically need to be active within several hundred milliseconds, and session notifications could then rapidly be broadcast out to the group.

Confirmed session setup methods are typically used when a response is expected or required from target users and/or terminals. Confirmed session setups may be used, for instance, when a session initiator wants to confirm the participation of the target endpoints within a session, that a session includes only those terminals having a user present, and/or that the target endpoints are ready to receive media. It will be appreciated by those of ordinary skill in the art that a session setup can also be a combination of confirmed and unconfirmed methods. For example, a majority of the session invitations can be unconfirmed, and only a few strategic or required users would receive confirmed session invitations.

Exemplary embodiments of each of the entities illustrated in FIG. 1 is described below, including exemplary functionality. It will be appreciated by those of ordinary skill in the art that each entity comprises a receiver for receiving information within the communications system, a transmitter for transmitting information within the communications network, and a processor for enabling the entity to perform various functions.

Each endpoint in the system, e.g., endpoints 140, 142 and 146, further comprise a unique user and terminal binding, wherein each terminal can be, for example, a dispatch terminal having push to talk (PTT) functionality to enable communication with the floor controller 130, the capability to affiliate itself with a group, and the capability to exchange media and control (SAP) via IP multicast. By contrast, non-dispatch terminals are unable to perform one or more of the above three functions. The endpoints further, in one embodiment, comprise both a SIP User Agent Client (UAC) and a SIP User Agent Server (UAS) to enable the endpoint to interact with the communications system to setup, modify, and terminate individual directed sessions, wherein an individual directed session is an invitation to at least one individual endpoint, e.g., point-to-point. In order to place or receive calls, an endpoint first registers with the system. When SIP signaling is utilized for session control signaling, a SIP REGISTER method can be used, wherein all SIP REGISTER requests are, for example, forwarded to the registration manager 102.

In some embodiments, the endpoints are also configured for receiving SAP announcements to inform the endpoint of the addition and removal of sessions. During a session, the endpoints can interact directly with the floor controller 130 for the purpose of controlling the source for a particular session's media streams. The protocol used for floor control interaction is specified in the SDP as part of the SIP and SAP session signaling.

Turning to the session controller 106, the session controller 106 maintains the state for sessions within its domain of control. For example, there may be multiple session controllers in a multi-zone system, as a function of factors such as system resources, such as wireless and wireline bandwidth, endpoint resources, (e.g., whether an endpoint is currently participating in another session, and capabilities of target endpoints). The session controller 106 is responsible for determining whether or not a requested multimedia session can be established, and works with the bandwidth manager 132 to reserve bandwidth and make the appropriate quality of service (QoS) reservations for a given session. The session controller 106 also works with the parameter resolver 114 to determine a corresponding set of session parameters usable during an accepted session.

The session controller 106 is one entity in the system with visibility into the sessions and the participants for the sessions. The session controller 106 can determine the availability of critical users using received information. When one or more critical users is not available, the session controller 106 can make a decision to queue the session. In addition, the session controller 106 may decide to remove a critical user from a low priority session to place this user in another higher priority session. Furthermore, the session controller 106 can receive information from the registration manager 102 regarding how many simultaneous sessions an endpoint can support, and therefore whether the endpoint can join a new session being setup.

The individual proxy 116 in one embodiment is a “stateful” SIP proxy (i.e. as described and utilized in SIP [RFC] 3261) that represents the signaling point of control through which the underlying session controller 106 can be accessed when an individual directed session (e.g. point-to-point) is setup between at least two endpoints. Each individual proxy 116 is instantiated by the individual proxy manager 118 on behalf of the requested session and has a life cycle substantially equal to the session. The individual proxy 116 inserts itself into the SIP route set of an individual directed session to insure that all session control signaling passes through the individual proxy 116 for possible handling by the underlying session controller 106. To the rest of the system and, most importantly, to the endpoints, the SIP signaling appears as being sent end to end even though the individual proxy 116 may change the SDP or indicate that a session cannot proceed. This allows adherence to the SIP standard and possibly, better compatibility with standard SIP devices.

In operation, the individual proxy 116 intercepts a SIP INVITE message from an initiating endpoint's UAC and then decides what endpoints to include in the new session based on the destination specified in the SIP INVITE message and the system policy information. It will be appreciated by those of ordinary skill in the art that multiple endpoints can be invited using methods such as the initiator specifying a pre-configured list, the list could be included explicitly in the INVITE (ex. in the SDP or in an extension header), or a similar alternative. Different policies, for example, may specify that a user is called at all of their associated terminals, called at their mobile terminals, or called at only the terminal specified in the SIP session setup request. Once the list of the endpoints has been selected, the individual proxy 116 determines a prioritized list of communication capabilities usable for the session. This information along with the list of requested session participants is sent to the session controller 106. If the session is granted, the individual proxy 116 sends the SIP session INVITE messages to all of the intended endpoints, and the session is setup. Moreover, the individual proxy 116 fills in the SIP FROM header with the address of the session initiator rather than its own address so that the individual proxy 116 remains invisible to the endpoints in the session.

As mentioned above, all individual directed session requests are intercepted by the individual proxy 11 6, which interacts with the session controller 106 to determine if the session should be established or denied. This determination is a function of factors that include the availability of system resources required to handle the session's traffic, endpoint resources and capabilities, or other parameters such as authentication, authorization, and access policies. The individual proxy 116 passes information on the requested session, as described by the payload of the SIP request, to the session controller 106. This information is usually in the form of a SDP packet. Through this interaction with the session controller 106, the individual proxy 116 routes the request to the intended recipient endpoint and returns the appropriate response to the session initiator. The interaction between the individual proxy 116 and the session controller 106 can occur through any of a number of conventional mechanisms such as IPC (Inter Process Communications) messaging, Remote Procedure Call (RPC) messaging, Common Object Request Broker Architecture (CORBA), Remote Method Invocation (RMI), or a proprietary inter-process communication means.

When the underlying session controller 106 informs the individual proxy 116 that the session may proceed, (i.e., the necessary system resources are available to handle the requested session), the individual proxy 116 functions as a normal SIP routing proxy except that it may re-write the SDP to enforce the session controller 106 determination of the updated session parameters (based on available bandwidth, policies, etc.). These updated parameters are returned to the initiating endpoint and the target endpoint using the normal SIP transactions, so that neither endpoint is aware that a third party has taken control of the session negotiation. If resources are not currently available for the requested session or the session controller 106 has determined that one of the endpoints is currently in another session which cannot be interrupted, the session controller 106 can instruct the individual proxy 116 to respond to the initiating endpoint with the appropriate SIP response to deny or queue the session request.

The session controller 106 can also instruct the individual proxy 116 to terminate the session between the endpoints at any time, independent of any requests from either endpoint if network conditions change during a connection or if either party needs to be invited into anther session. Individual proxy 116 would then send corresponding SIP BYE requests to each endpoint that would be formatted to appear to be part of the control dialog established between the endpoints.

To perform the above functions, the individual proxy 116 is either in the session initiator's initial route set, or through standard SIP routing conventions, the individual proxy 116 adds itself to the dialog's route set through, for instance, the appropriate use of SIP's RECORD-ROUTE header. This insures that any future SIP requests from either endpoint will be routed through the individual proxy 116 by use of the complementary SIP ROUTE header. Through this standard mechanism, all future SIP requests that might possibly effect the allocation of network resources will pass through the individual proxy 116 to be examined by the underlying session controller 106.

The parameter resolver 114 is configured for establishing at least one set of communication capabilities for an endpoint. These capabilities may include, for example, audio codecs, video codecs, screen size, full duplex, support for multicast, and the like. Once a set of capabilities is resolved, it can be saved in a database for future use in determining the corresponding session parameters for a session involving that given endpoint.

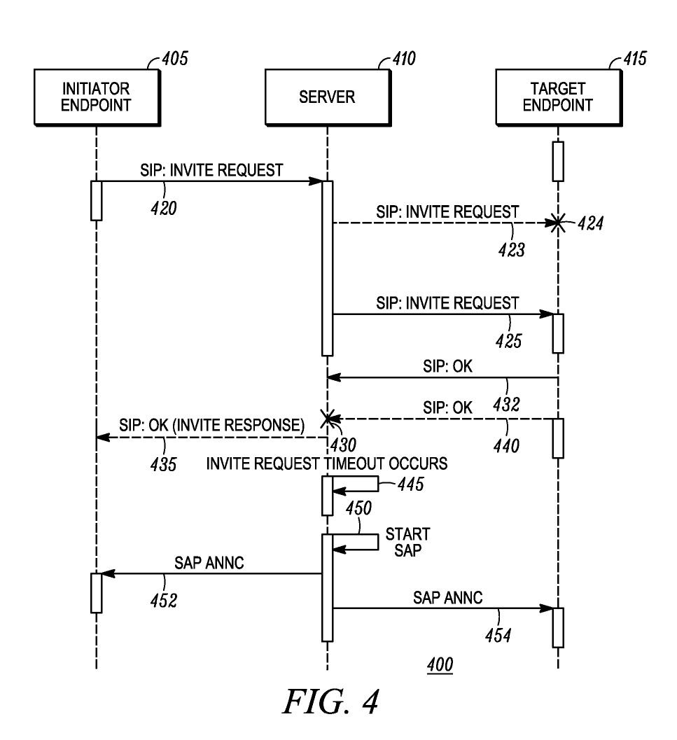

FIGS. 4 through 6 illustrate various messaging scenarios for implementation of the present invention within a communication network such as within the architecture 100 described previously herein. It will be appreciated by those of ordinary skill in the art that the messaging scenarios of FIGS. 4 through 6 are simplified herein for explanatory purposes and that other messaging may occur in accordance with standard protocol and network requirements.

Referring to FIG. 4, a network 400 comprises an initiator endpoint 405, a server 410, and a target endpoint 415. The initiator endpoint 405 and the target endpoint 415 can be, for example, one of the endpoints 140, 142, and 146 of the architecture 100 of FIG. 1. Although the exemplary network 400 illustrated in FIG. 4 includes two endpoints, it will be appreciated by those of ordinary skill in the art that a call having more than two endpoints is within the scope of the present invention. The server 410 can be, for example, the individual proxy 116 of FIG. 1, or alternatively, can be another network server communicatively coupled to the session controller 106 of FIG. 1.

As illustrated in FIG. 4, a communication session begins with the initiator endpoint 405 sending a SIP INVITE request 420 to the server 410. The server 410, in response to receiving the SIP INVITE request 420, then sends a new SIP INVITE request 423 to the target endpoint 415. In one scenario, the new SIP INVITE request 423 may not reach the target endpoint 415 and will thus become a lost message 424. In another scenario, the server 410 sends a new SIP INVITE request 425 to the target endpoint 415 and it reaches the target endpoint 415. However, in that scenario the server 410 may or may not receive acknowledgement that the new SIP invite request 425 actually reached its destination of the target endpoint 415. In the scenario that the new SIP INVITE request 425 reaches the target endpoint 415, the target endpoint 415 generates and transmits a SIP OK (INVITE Response) 432, 440 destined for the server 410. When the SIP OK (INVITE Response) 432 reaches the server 410, the server 410 generates and transmits a new SIP OK (INVITE Response) 435 to the initiator endpoint 405. When the SIP OK (INVITE Response) 440 does not reach the server 410, it becomes a lost message 430, as illustrated.

In accordance with the present invention, the server 410 is programmed with an INVITE timeout period. When the INVITE request times out at the predetermined INVITE request timeout 445, the server 410 starts sending SAP announcements 450. The server 410 then periodically sends a SAP announcement 452 to the initiator endpoint 405, and also periodically sends a SAP announcement 454 to the target endpoint 415. In response to receiving one or more SAP announcements 454, the target endpoint 415 will either start the session if the SIP INVITE request had never reached the target endpoint 415 or ignore the SAP if the SIP INVITE request had reached the target entpoint 415. It will be appreciated by those of ordinary skill in the art that the process illustrated in FIG. 4 is an exemplary embodiment, and that, in accordance with the present invention, the server 410 can alternatively start sending the SAP announcements 452, 454 to the target endpoint 415 and the initiator endpoint 405 at any time during the process.

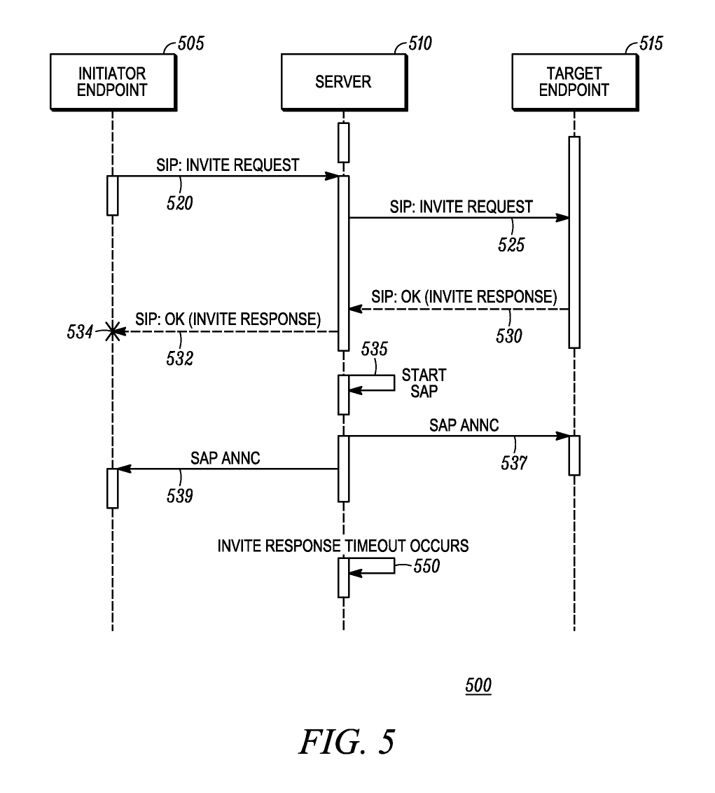

Referring to FIG. 5, a network 500 comprises an initiator endpoint 505, a server 510, and a target endpoint 515. The initiator endpoint 505 and the target endpoint 515 can be, for example, one of the endpoints 140, 142, and 146 of the architecture 100 of FIG. 1. Although the exemplary network 500 illustrated in FIG. 5 includes two endpoints, it will be appreciated by those of ordinary skill in the art that a call having more than two endpoints is within the scope of the present invention. The server 510 can be, for example, the individual proxy 116 of FIG. 1, or alternatively, the server 510 can be another network server communicatively coupled to the session controller 106 of FIG. 1.

As illustrated in FIG. 5, a communication session begins with the initiator endpoint 505 sending a SIP INVITE request 520 to the server 510. The server 510, in response to receiving the SIP INVITE request 520, then sends a new SIP INVITE request 525 to the target endpoint 515. In response to the new SIP INVITE request 525, the target endpoint 515 generates and transmits a SIP OK (INVITE Response) 530 destined for the server 510. When the server 510 receives the SIP OK (INVITE Response) 530, it next generates and transmits a new SIP: OK (INVITE Response) 532 to the initiator endpoint 505. In one scenario, the new SIP: OK (INVITE Response) 532 does not reach the initiator endpoint 505 and becomes a lost message 534.

In accordance with the present invention, the server 510 starts a SAP 535 at some point in the process. For example, the server 510 can start the SAP 535 after a predetermined period of time has passed. It will be appreciated by those of ordinary skill in the art that, in accordance with the present invention, the server 510 can alternatively start the SAP 535 at any time during the process. The server 510 then periodically sends a SAP announcement 537 to the target endpoint 515, and also periodically sends a SAP announcement 539 to the initiator endpoint 505.

The server 510 is programmed with an INVITE response timeout period. When the INVITE response times out at the predetermined timeout period 550, no action needs to be taken by the server 510 since the SAP 535 caused the initiator endpoint 505 to start the session.

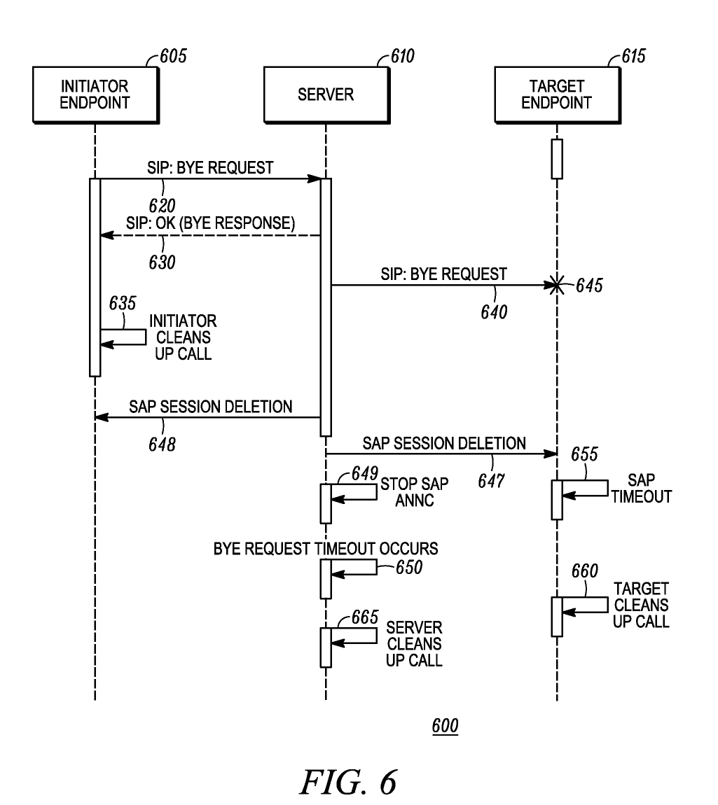

Referring to FIG. 6, a network 600 comprises an initiator endpoint 605, a server 610, and a target endpoint 615. The initiator endpoint 605 and the target endpoint 615 can be, for example, one of the endpoints 140, 142, and 146 of the architecture 100 of FIG. 1. Although the exemplary network 600 illustrated in FIG. 6 includes two endpoints, it will be appreciated by those of ordinary skill in the art that a call having more than two endpoints is within the scope of the present invention. The server 610 can be, for example, the individual proxy 116 of FIG. 1, or alternatively, the server 610 can be another network server communicatively coupled to the session controller 106 of FIG. 1.

As illustrated in FIG. 6, any endpoint within a communication session can initiate the ending of that communication session. For example, as illustrated, the initiator endpoint 605 can end a communication session by first sending a SIP BYE request 620 to the server 610. It will be appreciated by those of ordinary skill in the art that in order to send a the SIP BYE request 620, the endpoint that started the call due to a received SAP has to first perform the INVITE/OK/ACK exchange with the server 610 in accordance with the SIP protocol.

In response to receiving the SIP BYE request 620, the server 610 generates and transmits a SIP OK (BYE response) 630 to the initiator endpoint 605. In response to receiving the SIP OK (BYE response), the initiator endpoint 605 cleans up the call 635.

The server 610 also generates and transmits a SIP BYE request 640 destined for the target endpoint 615. In one scenario, the SIP BYE request 640 does not reach the target endpoint 615 and will thus become a lost message 645.

In accordance with the present invention, the server 610 next generates and transmits one or more SAP Session Deletion messages 648 to the initiator endpoint 605 and one or more SAP Session Deletion messages 647 to the target endpoint 615. The SAP Session Deletion messages 647, 648 are periodically sent for a predetermined time to inform the initiator endpoint 605 and the target endpoint 615 that the communication session has ended. The server 610 then stops the periodic generation of the SAP announcements 649. If the target client 615 receives the SAP Session Deletion 647 it will end the session. (not shown)

The server 610 preferably is programmed with a BYE request timeout period 650. After the SAP Session Deletion messages 647, 648 are transmitted, and the SAP announcements are stopped 649, and the BYE request timeout period 650 occurs, the server 610 will stop the periodic sending of the SAP Session Deletion messages 647, 648 to the initiator endpoint 605 and the target endpoint 615.

The target endpoint 615 is preferably programmed with a SAP timeout period. When the target endpoint 615 stops receiving SAP announcements, it will begin a session timeout timer and end the session after the SAP timeout period. Since the SAP timeout 655 will occur within the target endpoint 615, the target endpoint 615 will clean up the call 660 when the SAP timeout 655 occurs whether or not it actually received the SIP BYE request 640 or the SAP Session Deletion message 647. It will be appreciated by those of ordinary skill in the art that any endpoint within the communication session can clean up the call due to no longer receiving SAP announcements, in accordance with the present invention, and that the target endpoint 615 clean up of the call 660 as illustrated is for exemplary purposes only.

As illustrated, alternatively, the server 410 can clean up the call 665 when the BYE request times out 650.

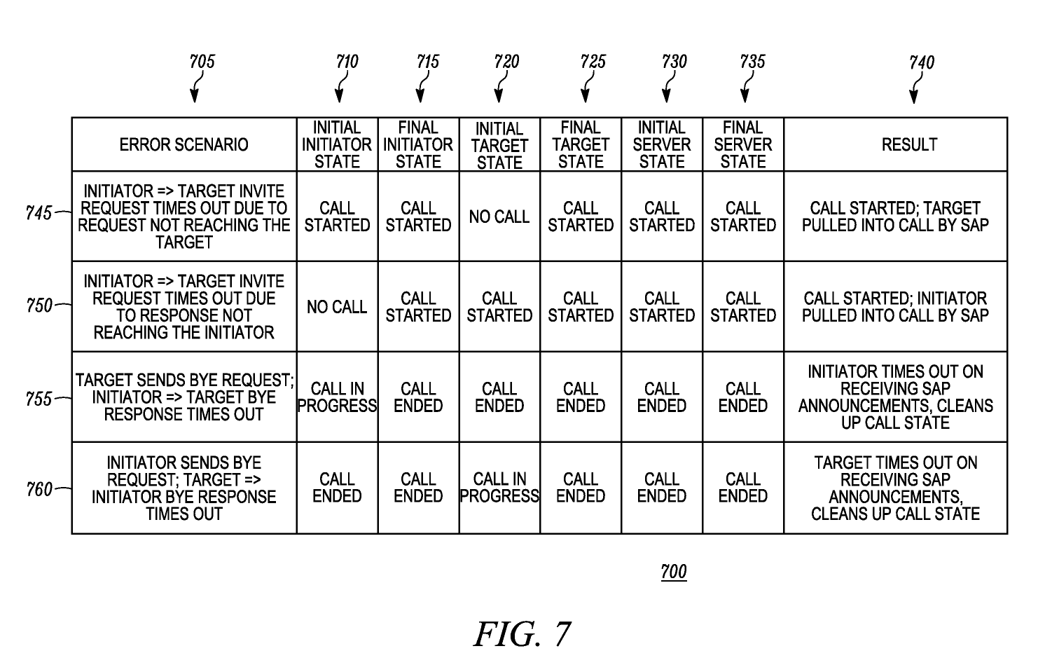

FIG. 7 illustrates a table 700 summarizing the state of the various components of a network for various error scenarios and the overall results when implementing the present invention. Specifically, the table 700 includes for each of the error scenarios 705, an initial initiator client state 710, a final initiator client state 715, an initial target client state 720, a final target client state 725, an initial server state 730, a final server state 735, and an overall result 740.

As shown in table 700 of FIG. 7, for call initiation 745, 750, using the various embodiments of the present invention results in the call consistently being setup on the initiator client, the target client, and the call server. The end result of implementing the present invention is a more reliable call setup mechanism. Also as shown in table 700, for session termination scenarios 755,760, using the various embodiments of the present invention results in the call state being synchronized across the initiator client, the target client, and the call server.

The present invention utilizes a lightweight call signaling mechanism including eliminating the need for periodic three-way messaging (re-INVITE/OK/ACK). Using only periodically repeated outbound messages (i.e. the SAP announcements) allows these messages to effectively be sent more often than in previous systems with less penalty. Additionally, the present invention will readily scale up to calls having large numbers of participants that are invited via SIP messaging (ex. multiparty individual calls).

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method for providing reliable session communication within a network comprising the steps of:
initiating a communication session by an endpoint using a transactional protocol to send a communication session request to a server;
sending a second communication session request from the server to the at least one other endpoint;
sending a session announcement generated using a broadcast protocol from the server to the at least one other endpoint; and
starting the communication session by the at least one other endpoint in response to receiving the broadcast protocol announcement.

2. A method for providing reliable session communication within a network as claimed in claim 1, further comprising the steps of:
receiving the second communication session request by the at least one other endpoint;
starting the communication session by the at least one other endpoint in response to receiving the communication session request; and
ignoring the announcement received from the server by the at least one other endpoint.

3. A method for providing reliable session communication within a network as claimed in claim 1, further comprising the steps of:
sending a communication session request response generated using the transactional protocol by the at least one other endpoint to the server in response to receiving the second communication session request; and
sending the communication session request response from the server to the endpoint.

4. A method for providing reliable session communication within a network as claimed in claim 1, further comprising the steps of:
determining whether a communication session request response generated using the transactional protocol by the at least one other endpoint is received by the server within a predetermined period of time prior to the sending the broadcast protocol announcement step; and
generating the broadcast protocol announcement when the communication request response is not received by the server within the predetermined time.

5. A method for providing reliable session communication within a network as claimed in claim 1, wherein the sending of the broadcast protocol announcement step comprises periodically sending the announcement to the at least one other endpoint.

6. A method for providing reliable session communication within a network as claimed in claim 1, further comprising the steps of:
sending the announcement generated using the broadcast protocol from the server to the endpoint; and
starting the communication session by the endpoint in response to receiving the announcement.

7. A method for providing reliable session communication within a network as claimed in claim 6, wherein the announcement is sent from the server to the endpoint at a predetermined time when a communication session request response has not been received by the server from the at least one other endpoint.

8. A method for providing reliable session communication within a network as claimed in claim 6, wherein the sending of the announcement to the endpoint step comprises periodically sending the announcement to the endpoint.

9. A method for providing reliable session communication within a network as claimed in claim 1, wherein the transaction protocol comprises a Session Initiation Protocol (SIP).

10. A method for providing reliable session communication within a network as claimed in claim 1, wherein the broadcast protocol comprises a Session Announcement Protocol (SAP).

11. A method for providing reliable session communication within a network as claimed in claim 9, wherein the broadcast protocol comprises a Session Announcement Protocol (SAP), wherein the communication session request comprises a SIP INVITE request, wherein the second communication session request comprises a second SIP INVITE request, and wherein the announcement comprises a SAP announcement.

12. A method for providing reliable session communication within a network as claimed in claim as claimed in claim 3, wherein the transaction protocol comprises a Session Initiation Protocol (SIP), wherein the broadcast protocol comprises a Session Announcement Protocol (SAP), wherein the communication session request comprises a SIP INVITE request, wherein the second communication session request comprises a second SIP INVITE request, and wherein the announcement comprises a SAP announcement, and wherein the communication session request response comprises a SIP OK (INVITE Response).

13. A method for providing reliable session communication within a network as claimed in claim 4, wherein the transaction protocol comprises a Session Initiation Protocol (SIP), and wherein the predetermined time period comprises a SIP INVITE request timeout period stored within the server.

14. A method for providing reliable session communication within a network as claimed in claim 1, further comprising the steps of:
initiating a termination of the communication session by an endpoint using the transactional protocol to send a communication session termination request to the server;
ending the transmission of one or more broadcast protocol announcements from the server to at least one endpoint participating within the communication session; and
cleaning up the communication session by the at least one endpoint at a timeout period after not receiving broadcast protocol announcements.

15. A method for providing reliable session communication within a network as claimed in claim 14, further comprising, after the initiating step, the steps of:
sending a communication session termination request response generated using the transactional protocol from the server to the endpoint; and
cleaning up the communication session by the endpoint in response to receiving the communication session termination request response.

16. A method for providing reliable session communication within a network as claimed in claim 14, further comprising, after the initiating step, the steps of:
transmitting the communication session termination request from the server to the at least one endpoint; and
cleaning up the communication session by the at least one endpoint in response to receiving the communication session termination request response.

17. A method for providing reliable session communication within a network as claimed in claim 14, further comprising, after the initiating step, the steps of:
sending a broadcast protocol terminate session message from the server to the at least one endpoint to inform the at least one endpoint that the communication session has ended.

18. A method for providing reliable session communication within a network as claimed in claim 14, wherein the transaction protocol comprises a Session Initiation Protocol (SIP).

19. A method for providing reliable session communication within a network as claimed in claim 14 wherein the broadcast protocol comprises a Session Announcement Protocol (SAP).

20. A method for providing reliable session communication within a network as claimed in claim 18, wherein the broadcast protocol comprises a Session Announcement Protocol (SAP), wherein the communication session termination request comprises a SIP BYE request, and wherein the one or more broadcast protocol announcements comprise one or more SAP announcements.

21. A method for providing reliable session communication within a network as claimed in claim 15, wherein the transaction protocol comprises a Session Initiation Protocol (SIP), wherein the communication session termination request comprises a SIP BYE request, and wherein the communication session termination request response comprises a SIP OK (BYE response).

22. A method for providing reliable session communication within a network as claimed in claim 17, wherein the broadcast protocol comprises a Session Announcement Protocol (SAP), and wherein the broadcast protocol terminate session message comprises a SAP Session Deletion message.

23. A method for providing reliable session communication within a network comprising the steps of:
initiating a communication session by an endpoint using a Session Initiation Protocol (SIP) to send a SIP INVITE request to a server;
sending a second SIP INVITE request from the server to the at least one other endpoint;
sending a SAP announcement generated using a Session Announcement Protocol (SAP) from the server to the at least one other endpoint; and
starting the communication session by the at least one other endpoint in response to receiving the SAP announcement.

24. A method for providing reliable session communication within a network as claimed in claim 23, further comprising the steps of:
initiating a termination of a communication session by an endpoint using a Session Initiation Protocol (SIP) to send a SIP BYE request to a server;
ending the transmission of one or more SAP announcements generated using a Session Announcement Protocol (SAP) from the server to at least one endpoint participating within the communication session; and
cleaning up the communication session by the at least one endpoint at a timeout period after not receiving SAP announcements.
